(19) United States
(12) Patent Application Publication
(10) Pub. No.: US 2023/0172181 A1
(43) Pub. Date: Jun. 8, 2023

(54) OUTRIGGER ROLLER ASSEMBLY

(71) Applicant: GEM Products, Inc., Jacksonville, FL (US)

(72) Inventor: Jason Sarnowski, St. Augustine, FL (US)

(73) Assignee: GEM Products, Inc., Jacksonville, FL (US)

(21) Appl. No.: 17/544,901

(22) Filed: Dec. 7, 2021

(51) Int. Cl. A01K 91/08; A01K 87/02; A01K 87/04

(52) U.S. Cl. CPC A01K 91/08; A01K 87/025; A01K 87/04

(57) ABSTRACT

A roller assembly for guiding lines. The roller assembly includes a shaft adapted to couple to a receiving area of the line guide, and a roller rotatably coupled to the shaft and including grooves adapted to respectively receive guide lines. A distance between an outer surface of the roller and a surface of the receiving area may be less than a thickness of the lines.

### TECHNICAL FIELD OF THE INVENTION

The present invention relates generally to outrigger line guides. More particularly, the present invention relates to an outrigger roller assembly for guiding outrigger lines.

### BACKGROUND OF THE INVENTION

Outriggers are popular in fishing applications. Outriggers are rigid poles that are a part of the boats rigging and are designed to extend the fishing pole bait lines beyond the “white wash” of the water surrounding the boat. This is preferable because bait traveling through clear water is more likely to successfully attract a fish. Once a fish takes the bait, the line is automatically released from the outrigger and all forces are transferred directly to a fishing pole secured to the gunnel of the boat. For example, the bait line can be connected to a quick release mechanism that releases the line and transfers the forces to the pole when a fish engages the bait or otherwise pulls on the line.

Outriggers typically include several nestable tubes connected to one another by clamps. The clamps can secure the tubes together when the outrigger is arranged in the extended position to prevent the tubes from collapsing upon one another. Also, the clamps can secure the tubes together when the outrigger is arranged in a collapsed position, thereby to preventing the tubes from moving outward.

Outriggers clamps typically include line guides for guiding outrigger lines. The respective outrigger lines pass through the line guides and connect to the quick release mechanism to extend the bait line a desired distance from the boat when the outrigger is in the extended position. The line guides are preferably oriented parallel to one another. In doing so, the force applied to the outrigger line by the bait line is coplanar with an axis of the clamp at a point furthermost from the boat, allowing for a structurally stable configuration.

Current outriggers typically use line guides that have multiple rollers, where each roller is dedicated to a single outrigger line. Such multiple roller line guides for outriggers are described, for example, in U.S. Pat. No. 11,116,197. For example, to manage three outrigger lines, a conventional line guide uses three individual rollers. During operation, only one of the outrigger lines is in tension, which restricts the roller managing the outrigger line in tension from moving. Accordingly, the two rollers managing the outrigger lines that are not in tension can freely rotate which can create a rattling noise. Additionally, to prevent tangling of the lines, the line guides of current outriggers have structures that separate the rollers or otherwise restrict the lines from crossing. Accordingly, due to the numerous amounts of small parts required by conventional outrigger line guides, manufacturing of current outrigger line guides is time consuming, complex, and expensive.

### SUMMARY OF THE INVENTION

The present invention relates broadly to an outrigger line guide having an outrigger roller assembly for an outrigger clamp capable of securing two or more nestable tubes. The outrigger line guide guides the outrigger lines using the outrigger roller assembly. The outrigger roller assembly includes a single roller having multiple grooves that respectively guide one of the outrigger lines. A distance between an outer diameter of the roller and a surface of the outrigger line guide may be less than a thickness of the outrigger line, thereby restricting the outrigger lines from crossing each other on the roller assembly. Thus, the outrigger roller assembly guides the outrigger lines in a manner to restrict inadvertent tangling of the lines. Accordingly, the outrigger line guide of the present invention requires fewer components and is easier and less expensive to manufacture, compared to conventional outrigger guides. Additionally, during operation, at least one of the outrigger lines is kept in tension, which restricts rotational movement of the roller, thereby reducing unwanted rattling noises that occur with conventional outrigger guides.

In an embodiment, the present invention broadly comprises a roller assembly for guiding lines having respective diameters. The roller assembly includes a shaft adapted to couple to a receiving area of the line guide, and a roller rotatably coupled to the shaft and that includes grooves adapted to respectively receive the lines. A distance between an outer surface of the roller and a surface of the receiving area may be less than a diameter of the smallest line. The grooves do not rotate relative to each other.

In another embodiment, the present invention broadly comprises an outrigger that includes a tube having an axis. The outrigger includes a line guide including a receiving area and rotatably coupled to the tube, where the line guide is adapted to rotate about the axis, and a roller assembly disposed within the receiving area. The roller assembly includes a shaft adapted to couple to the receiving area of the line guide, and a roller rotatably coupled to the shaft and that includes grooves adapted to respectively receive lines having respective diameters. A distance between an outer surface of the roller and a surface of the receiving area may be less than a diameter of the smallest outrigger line.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

FIG. 1 is a perspective view of an exemplary outrigger having exemplary outrigger line guides and disposed in an collapsed position, according to an embodiment of the present invention.

FIG. 2 is a perspective view of an exemplary outrigger having exemplary outrigger line guides and disposed in an expanded position, according to an embodiment of the present invention.

FIG. 3 is a perspective, disassembled view of one of the outrigger line guides of FIG. 1.

FIG. 4 is an assembled side view of one of the outrigger line guides of FIG. 1.

FIG. 5 is an assembled top view of one of the outrigger line guides of FIG. 1.

FIG. 6 is a perspective view of an exemplary tip of the outrigger of FIG. 1.

FIG. 7 is a front view of an exemplary roller having a single groove according to an embodiment of the present invention.

FIG. 8 is a front view of an exemplary roller having two grooves according to an embodiment of the present invention.

FIG. 9 is a front view of an exemplary roller having three grooves according to an embodiment of the present invention.

FIG. 10 is a side view of the roller of FIG. 9.

FIG. 11 is a perspective view of the roller of FIG. 9.

FIG. 12 is a perspective view of an exemplary roller assembly, according to an embodiment of the present invention.

FIG. 13 is a perspective, disassembled view of the roller assembly of FIG. 12.

FIG. 14 is a front, assembled view of the roller assembly of FIG. 12.

### DETAILED DESCRIPTION OF THE INVENTION

While the present invention is susceptible of embodiments in many different forms, there is shown in the drawings, and will herein be described in detail, embodiments of the invention, including a preferred embodiment, with the understanding that the present disclosure is to be considered as an exemplification of the principles of the present invention and is not intended to limit the broad aspect of the invention to any one or more embodiments illustrated herein. As used herein, the term “present invention” is not intended to limit the scope of the claimed invention, but is instead used to discuss exemplary embodiments of the invention for explanatory purposes only.

The present invention relates broadly to an outrigger line guide having an outrigger roller assembly for an outrigger clamp capable of securing two or more nestable tubes. The outrigger line guide guides the outrigger lines using the outrigger roller assembly. The outrigger roller assembly includes a single roller having multiple grooves that respectively guide one of the outrigger lines. A distance between an outer diameter of the roller and a surface of the outrigger line guide may be less than a thickness of the outrigger line, thereby restricting the outrigger lines from inadvertently crossing each other. Thus, the outrigger roller assembly guides the outrigger lines in a manner to restrict tangling of the outrigger lines. Accordingly, the outrigger line guide of the present invention requires fewer components and is easier and less expensive to manufacture compared to current outrigger guides. Additionally, during operation, at least one of the outrigger lines is kept in tension, which restricts rotational movement of the roller, thereby reducing unwanted rattling noises that occur in conventional outrigger guides.

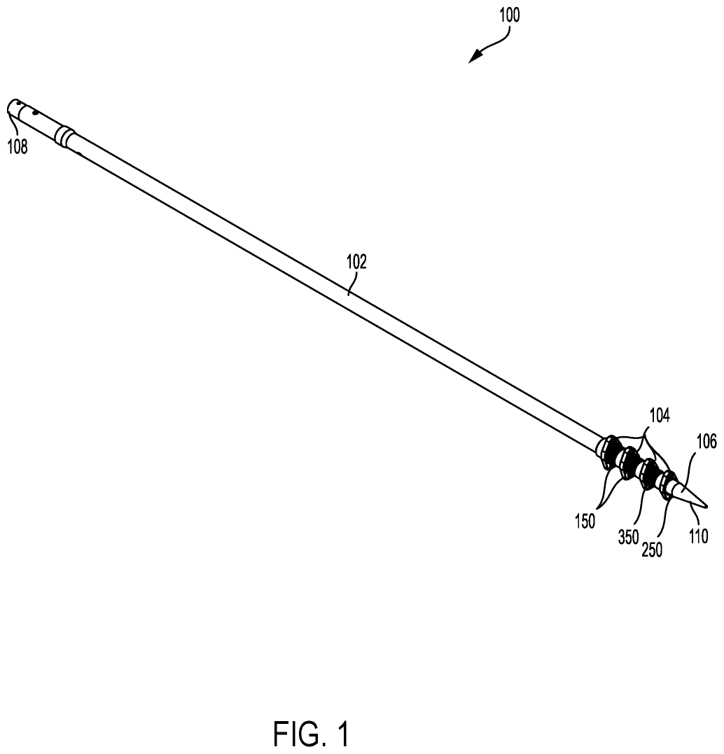

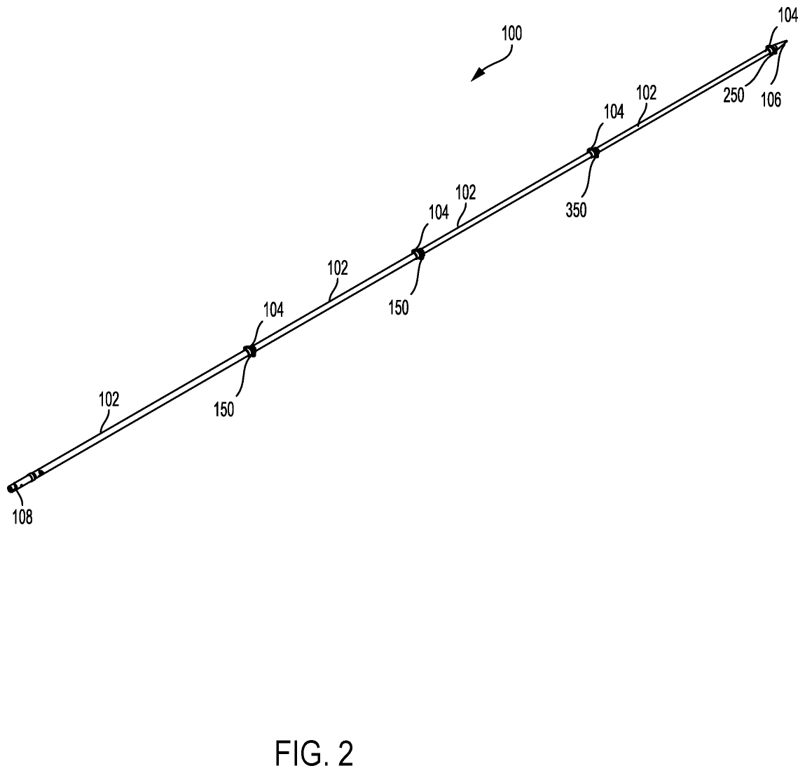

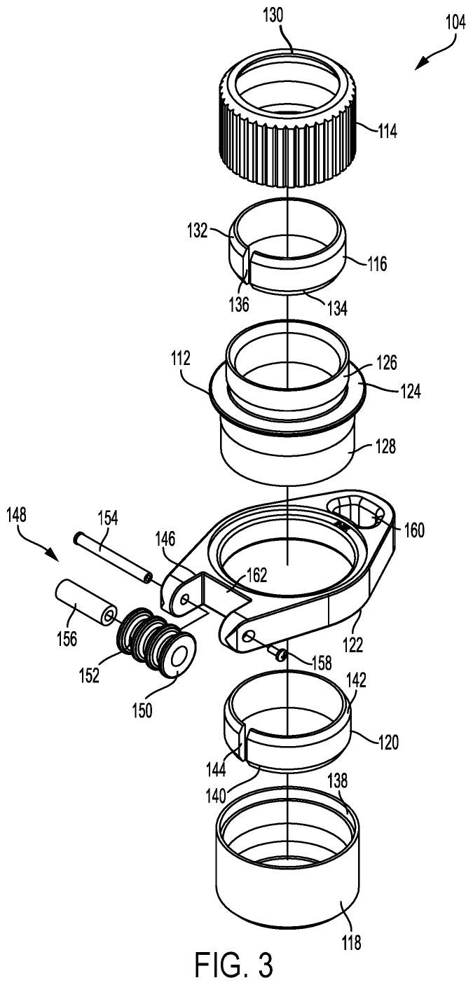

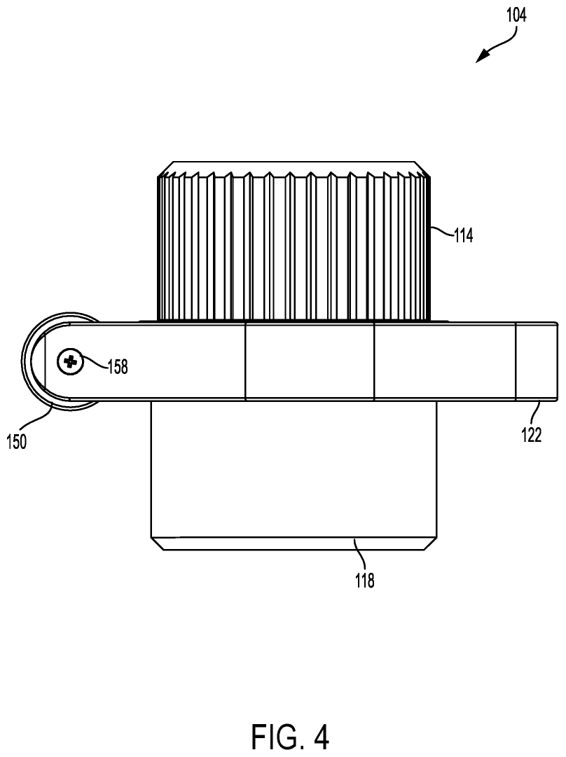

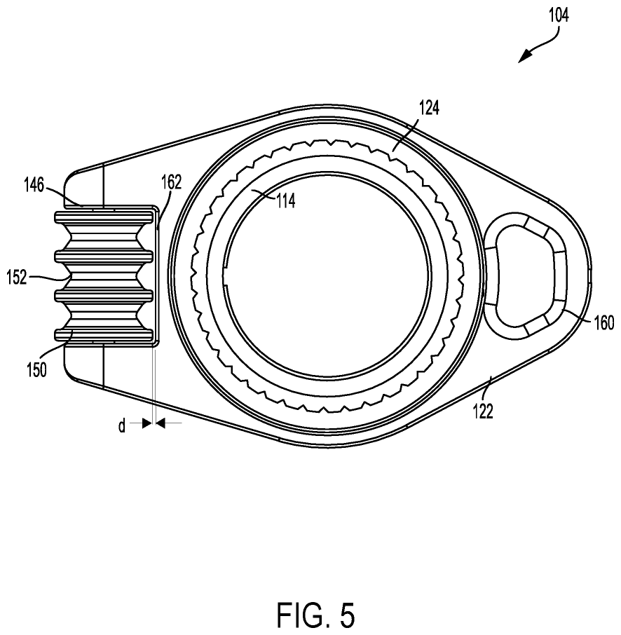

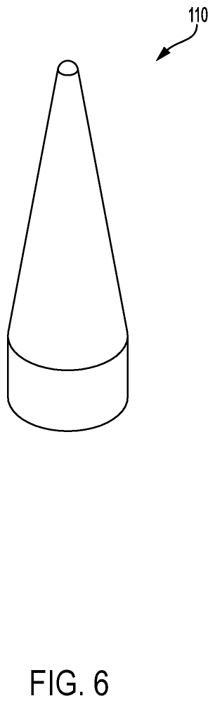

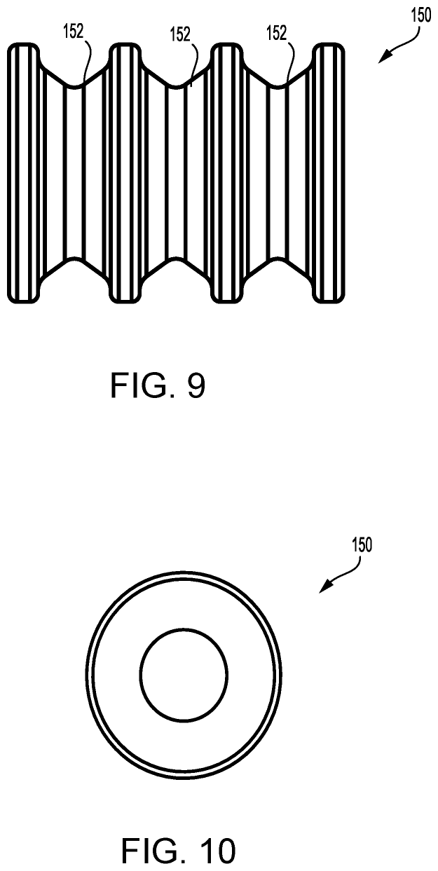

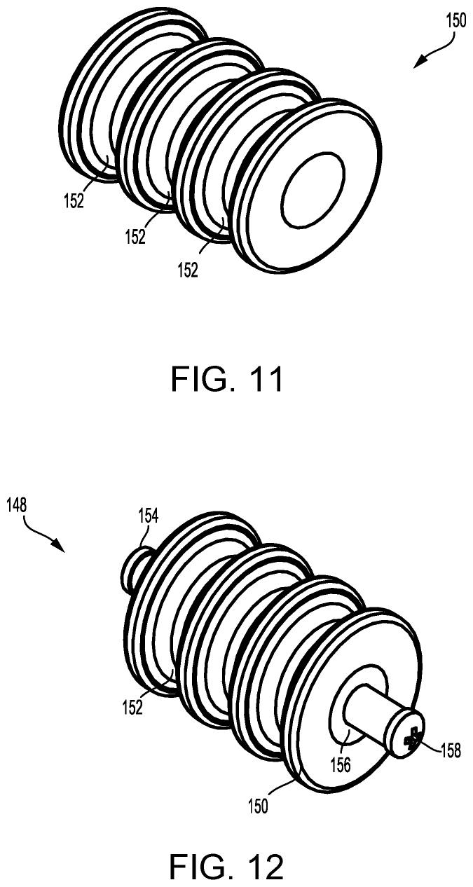

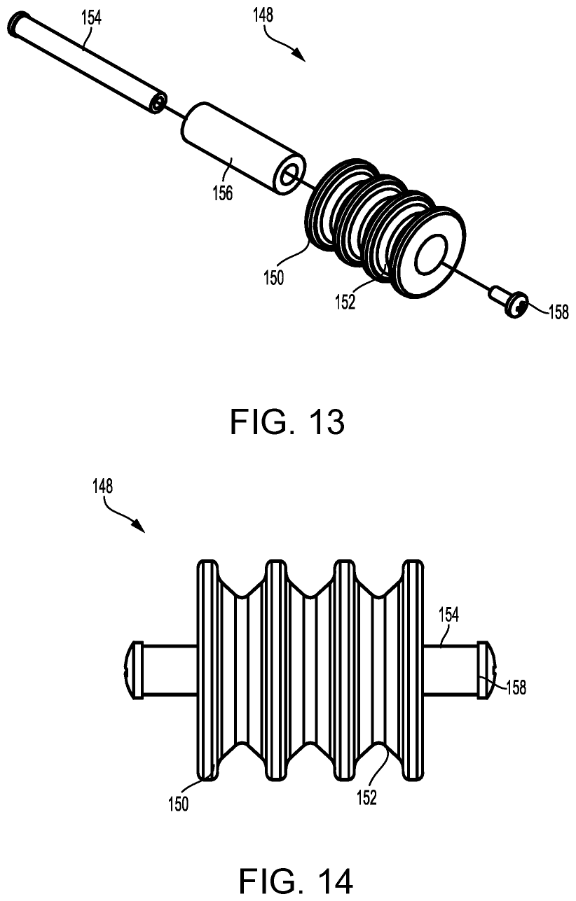

Referring to FIGS. 1-14, an outrigger 100 includes nestable tubes 102 coupled together via clamps 104. The nestable tubes 102 include a longitudinal axis. The outrigger includes first 106 and second 108 opposing ends. The second end 108 is adapted to be received by a mount disposed on a boat in a well-known manner. In an embodiment, the first end 106 includes a tip 110.

The clamp 104 includes a coupling portion 112, a first cap 114, a first split ring 116, a second cap 118, a second split ring 120, and a line guide 122. Although the line guide 122 is described in an exemplary embodiment as being coupled to the clamp 104, the invention is not limited as such, and the line guide 122 may be rotatably disposed at any suitable location along the tubes 102 using known methods. A flange 124 extends circumferentially from the coupling portion 112 between first and second opposing ends of the coupling portion 112. A first threaded portion 126 extends in a first axial direction from the flange 124 to the first end of the coupling portion 112, and a second threaded portion 128 extends in a second axial direction, opposite the first axial direction) from the flange 124 to the second end of the coupling portion 112.

The first cap 114 includes a first cap chamfer 130 proximal to an end of the first cap 114. The first split ring 116 includes opposing first and second ring chamfers 132 and 134. The first split ring 116 includes a gap 136 extending through the first split ring 116 to allow the first split ring 116 to apply a compressive force against an outside periphery of a first of two nestable tubes 102. The second ring chamfer 134 is disposed proximate the first threaded portion 126. As the first cap 114 is threaded onto the first threaded portion 126, an end of the first threaded portion 126 pushes against the second ring chamfer 134, and the first cap chamfer 130 pushes against the first ring chamfer 132, thereby causing the gap 136 in the split ring 116 to close. By closing the gap 136, the diameter of the first split ring 116 decreases and causes a compressive force to be applied to the first of the two nestable tubes 102 when the tube is disposed within the first cap 114, the first split ring 116, and the first threaded portion 126. In this manner, the combination of the first cap 114 and first split ring 116 is one example of a clamping mechanism that provides a compressive force. However, other clamping mechanisms, such as, for example, clamping mechanisms disclosed in U.S. Pat. Nos. 10,575,512 and 10,337,547, can be implemented without departing from the spirit and scope of the present invention.

The second cap 118 includes internal threads and a second cap chamfer 138 proximal to an end of the second cap 118. The second split ring 120 includes opposing first and second ring chamfers 140 and 142. The second split ring 120 includes a gap 144 extending through the second split ring 120 to allow for the second split ring 120 to apply a compressive force against an outside periphery of a second of two nestable tubes 102 of the outrigger 100. The second split ring 120 is disposed proximate the second threaded portion 128 with the second ring chamfer 142 engaging an end of the threaded portion 128 as the second cap 118 is threaded onto the second threaded portion 128.

As the second cap 118 is threaded onto the second threaded portion 128, the second cap chamfer 138 pushes against the first ring chamfer 140, and the end of the second threaded portion 128 pushes against the second ring chamfer 142, thereby causing the gap 144 in the second split ring 120 to close. By closing the gap 144, the diameter of the second split ring 120 decreases and causes a compressive force to be applied to the second of the two nestable tubes 102 when the tube is disposed within the second cap 118, the second split ring 120, and the second threaded portion 128 of the coupling portion 112. However, other clamping mechanisms, such as, for example, clamping mechanisms disclosed in U.S. Pat. Nos. 10,575,512 and 10,337,547, can be implemented without departing from the spirit and scope of the present invention.

The line guide 122 is disposed on the coupling portion 112 between the flange 124 and the second cap 118 to restrict the line guide 122 from moving in an axial direction relative to the clamp 104, but still allowing free rotational movement of the line guide 122 relative to the tubes 102. Since the line guide 122 is freely rotatable about the longitudinal axis of the tubes 102, the outrigger 100 and outrigger line(s) are able to align themselves without manual adjustment during operation of the outrigger 100, thereby resulting in a user friendly and structurally stable configuration. Although the line guide 122 is described as being coupled to the clamp 104, the invention is not limited as such, and the line guide 122 may be rotatably disposed at any suitable location along the tubes 102 using known methods.

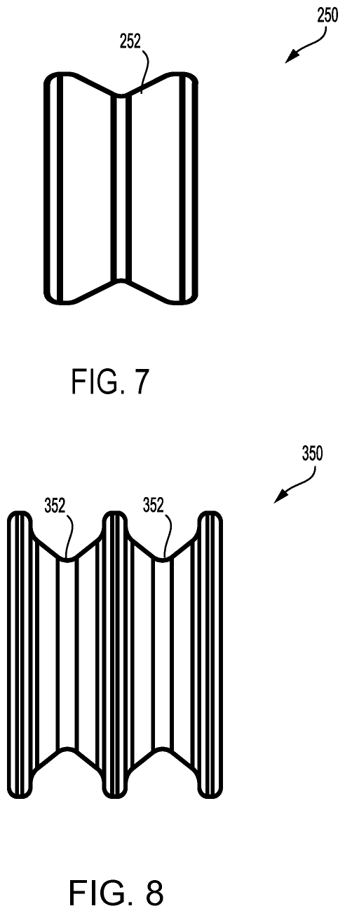

The line guide 122 includes a receiving area 146 for receiving a roller assembly 148. The receiving area 146 and the roller assembly 148 cooperatively receive and guide the outrigger line(s). The roller assembly 148 includes a roller 150 that allow the outrigger line(s) to move axially along the outrigger 100 without creasing or crimping, compared to a more rigid hook or fish eye fasteners. Moreover, the roller 150 includes grooves 152 that respectively guide outrigger lines. In an embodiment, the roller 150 includes three grooves 152 for respectively guiding three outrigger lines. However, a roller with more or fewer grooves can be implemented without departing from the spirit and scope of the present application. For example, as illustrated in FIGS. 7 and 8, a roller 250 with a single groove 252 and/or a roller 350 with two grooves 352 can be implemented on the outrigger 100 in addition to or instead of the roller 150. For example, the clamp 104 proximate the first end 106 can include the roller 250 to guide a single outrigger line, and one or more of the remaining clamps 104 of the outrigger 100 can include roller 350 and/or roller 150 for guiding multiple outrigger lines. The grooves 152, 252, 352 can be V or U shaped to respectively guide the outrigger line to a center of the respective groove 152. The outer diameter of the rollers 150, 250, 350 is dimensioned to restrict the outrigger lines from exiting the groove 152, 252, 352 and crossing. In other words, the distance d between a surface 162 of the receiving area 146 and an outer surface of the rollers 150, 250, 350 is less than the a diameter of the smallest(i.e., thinnest) outrigger line. In an embodiment, the outer diameter of rollers 150, 350 are approximately 0.62 inches, the outer diameter of the roller 250 is approximately 0.5 inches, and the distance d is approximately 0.020 inches. However, the invention is not limited to these dimensions and any suitable dimensions may be used. Thus, unlike current outriggers that utilize multiple rollers, the line guide 122 of the present invention does not require additional structures to prevent the outrigger lines from crossing.

The roller assembly 148 further includes a shaft 154 and a bearing 156. The bearing 156 can be pressed to the roller 150 and/or otherwise disposed between an inner surface the roller 150 and the shaft 156 using known methods. In an embodiment, the bearing 156 is a bushing. The shaft 154 functions as an axle and rotatably couples the bearing 156 and roller 150 to the line guide 122. In an embodiment, the shaft 154 is retained to the line guide 122 via a fastener 158, such as for example, a bolt, pin, rivet, etc.

In operation, when the outrigger 100 manages, for example, three outrigger lines, adjustment of one of the outrigger lines (i.e., only one of the outrigger lines is moved), will cause the roller 150 to rotate in one of the clockwise and counterclockwise directions, thereby causing the roller 150 to rotate relative to the stationary outrigger lines (i.e., the lines that are not being adjusted).

In an embodiment, the line guide 122 includes an attachment point 160 that allows accessories to be coupled to the line guide 122 without interfering with the outrigger line(s). The accessories can be coupled to the attachment point using, for example, a hook ring, D-clip, or other well-known means. Although a single attachment point 160 is shown, additional attachment points can be implemented without departing from the spirit and scope of the present invention. The attachment point 160 can be a substantially round shape, a substantially rectangular shape, a substantially triangular shape, a substantially trapezoidal shape, or any other suitable geometric shape. Some examples of accessories that can be coupled to the attachment point 160 include, but are not limited to, lights, a flag, clips/tethers for other accessories, etc. The attachment point 160 thus allows a user to attach accessories to the line guide 122 without interfering with the retained outrigger line(s), and without requiring the user to go through the time-consuming process of uninstalling and reinstalling the retained outrigger line(s).

In another embodiment, the tip 110 is coupled to the clamp 104 proximate the first end 106 of the outrigger 100. In this embodiment, the tip 110 is threadably coupled to the first threaded portion 126 instead of the first cap 114. In this embodiment, the clamp 104 includes roller 250 having a single groove 252.

As discussed herein, the present invention can be utilized with an outrigger, for example, that includes nestable tubes. However, the invention is not limited to an outrigger with nestable tubes or an outrigger. Further, the present invention contemplates that the receiving area 146 and roller 150 cooperatively guide an outrigger line. However, any type of line, such as a fishing line, filament, string, rope, or other suitable object, can be received and retained without departing from the spirit and scope of the present invention.

As used herein, the term “coupled” can mean any physical, electrical, magnetic, or other connection, either direct or indirect, between two parties. The term “coupled” is not limited to a fixed direct coupling between two entities.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of the inventors' contribution. The actual scope of the protection sought is intended to be defined in the following claims when viewed in their proper perspective based on the prior art.

What is claimed is:

1. A roller assembly for guiding lines having respective line diameters, the roller assembly comprising:
a shaft adapted to couple to a receiving area of a line guide; and
a roller rotatably coupled to the shaft and including grooves adapted to respectively receive the lines, wherein the grooves do not rotate relative to each other.

2. The roller assembly of claim 1, further comprising a bearing disposed between the shaft and roller.

3. The roller assembly of claim 2, wherein the bearing is a bushing.

4. The roller assembly of claim 1, wherein the shaft is retained to the line guide via a fastener.

5. The roller assembly of claim 1, wherein an outer diameter of the roller is about 0.62 inches.

6. The roller assembly of claim 1, wherein a distance between an outer surface of the roller and a surface of the receiving area is less than a smallest of the line diameters.

7. The roller assembly of claim 6, wherein the distance is about 0.020 inches.

8. The roller assembly of claim 1, wherein the grooves are one of V-shaped and U-shaped grooves.

9. The roller assembly of claim 1, wherein the roller includes three grooves.

10. An outrigger including a tube having a longitudinal axis and outrigger lines having respective outrigger line diameters, the outrigger comprising:
a line guide including a receiving area and rotatably coupled to the tube, wherein the line guide is adapted to rotate about the longitudinal axis; and
a roller assembly disposed within the receiving area and including:
a shaft coupled to the receiving area of the line guide; and
a roller rotatably coupled to the shaft and including grooves adapted to respectively receive the outrigger lines.

11. The outrigger of claim 10, wherein the tube includes first and second nestable tubes.

12. The outrigger of claim 10, wherein an outer diameter of the roller is about 0.62 inches.

13. The outrigger of claim 10, wherein a distance between an outer surface of the roller and a surface of the receiving area is less than a smallest of the line diameters.

14. The outrigger of claim 10, wherein the distance is about 0.020 inches.

15. The outrigger of claim 10, further comprising a bearing disposed between the shaft and roller.

16. The outrigger of claim 15, wherein the bearing is a bushing.

17. The outrigger of claim 10, wherein the shaft is retained to the line guide via a fastener.

18. The outrigger of claim 10, wherein the grooves are one of V-shaped and U-shaped grooves.

19. The outrigger of claim 10, wherein the roller includes three grooves.
